(19) United States
(12) Patent Application Publication
(10) Pub. No.: US 2019/0107052 A1
(43) Pub. Date: Apr. 11, 2019

(54) TURBOCHARGER

(71) Applicant: IHI Corporation, Koto-ku (JP)

(72) Inventors: Fumihiko FUKUHARA, Tokyo (JP); Shinichi Kaneda, Tokyo (JP); Tomomi Sugiura, Tokyo (JP)

(73) Assignee: IHI Corporation, Koto-ku (JP)

(21) Appl. No.: 16/212,824

(22) Filed: Dec. 7, 2018

Related U.S. Application Data
(63) Continuation of application No. PCT/JP2017/027443, filed on Jul. 28, 2017.

(30) Foreign Application Priority Data
Aug. 10, 2016 (JP) 2016-157170

(51) Int. Cl. F02C 7/06; F02C 6/12; F01D 25/16; F16C 17/02

(52) U.S. Cl. CPC F02C 7/06; F02C 6/12; F01D 25/162; F16C 2360/24; F05D 2220/40; F05D 2240/54; F05D 2240/60; F16C 17/02

(57) ABSTRACT

A turbocharger includes: a housing; a bearing member provided in the housing and having bearing surface; and a shaft having received surface facing the bearing surface, respectively, in a direction of a rotational axis and a large diameter portion extending from an outer periphery of the received surface and formed with a separation portion spaced apart from the bearing surface more than the received surface is.

### CROSS REFERENCE TO RELATED APPLICATIONS

This application is a continuation application of International Application No. PCT/JP2017/027443, filed on Jul. 28, 2017, which claims priority to Japanese Patent Application No. 2016-157170, filed on Aug. 10, 2016, the entire contents of which are incorporated by reference herein.

### BACKGROUND ART

### Technical Field

The present disclosure relates to a turbocharger including a shaft and a bearing surface.

### Related Art

Conventionally, turbochargers provided with a shaft is known. One end of the shaft is provided with a turbine impeller. The other end of the shaft is provided with a compressor impeller. In a turbocharger, the turbine impeller rotates by exhaust gas discharged from an engine. When the turbine impeller rotates, the compressor impeller rotates. The rotation of the compressor impeller compresses the air. The compressed air is delivered to the engine.

Patent Literature 1 discloses a turbocharger in which a bearing member is accommodated in a bearing hole formed in a housing. The bearing member pivotally supports the shaft in a freely rotatable manner.

### CITATION LIST

### Patent Literature

Patent Literature 1: Japanese Patent Application Laid-Open No. 2005-133635

### SUMMARY

### Technical Problem

Generally, parts such as shafts, impellers, and bearing members have different designs depending on specifications of a turbocharger. Therefore, each part is manufactured for each specification. Therefore, there is a demand for a turbocharger that allows parts to be shared even among different specifications.

An object of the present disclosure is to provide a turbocharger that allows common parts to be used even when specifications are different.

### Solution to Problem

In order to solve the above problem, a turbocharger according to one aspect of the present disclosure includes: a housing; a bearing member provided in the housing and having a bearing surface; and a shaft having a received surface facing the bearing surface in a direction of a rotational axis and a large diameter portion extending from an outer periphery of the received surface and formed with a separation portion spaced apart from the bearing surface more than the received surface is.

The separation portion may have a tapered shape.

The separation portion may include a separation surface positioned radially outward from the received surface and a step positioned between the separation surface and the received surface.

An outer diameter of the received surface may be smaller than an outer diameter of the bearing surface.

The bearing member may have the bearing surface at an end of an annular main body portion through which the shaft is inserted.

### Effects of Disclosure

According to the present disclosure, even when specifications are different, common parts can be used.

### BRIEF DESCRIPTION OF DRAWINGS

FIG. 1 is a schematic cross-sectional view of a turbocharger.

FIG. 2 is a view extracted from a one-dot chain line part of FIG. 1.

FIG. 3A is a view illustrating a broken line part on the left side in FIG. 2. FIG. 3B is a view illustrating a broken line part on the right side in FIG. 2.

FIG. 4A is a view for explaining a first modification. FIG. 4B is a view for explaining a second modification. FIG. 4C is a view for explaining a third modification.

FIG. 5 is a view for explaining a bearing structure of a second embodiment.

### DESCRIPTION OF EMBODIMENTS

An embodiment of the present disclosure will be described in detail below with reference to the accompanying drawings. Dimensions, materials, other specific numerical values, and the like illustrated in the embodiment are merely examples for facilitating understanding, and the present disclosure is not limited thereto except for a case where it is specifically mentioned. Note that, in the present specification and the drawings, elements having substantially the same function and structure are denoted by the same symbol, and redundant explanations are omitted. Illustration of components not directly related are omitted.

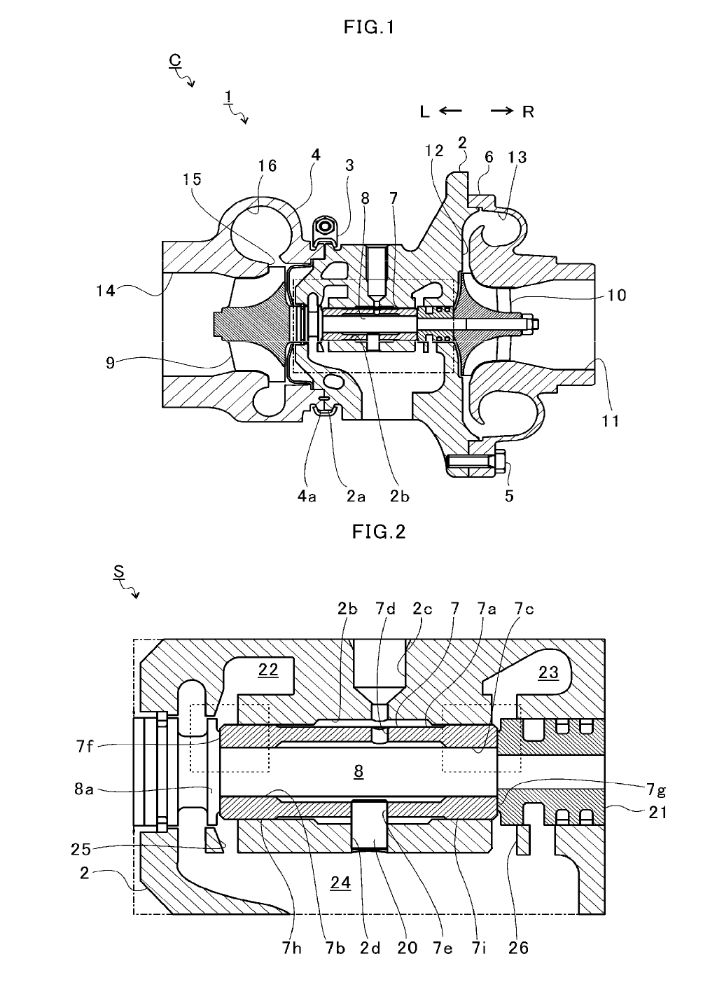

FIG. 1 is a schematic cross-sectional view of a turbocharger C. Hereinafter, descriptions are given assuming that a direction of an arrow L illustrated in FIG. 1 is the left side of the turbocharger C. Descriptions are given assuming that a direction of an arrow R illustrated in FIG. 1 is the right side of the turbocharger C. As illustrated in FIG. 1, the turbocharger C includes a turbocharger main body 1. The turbocharger main body 1 includes a bearing housing 2 (housing). A turbine housing 4 is connected to the left side of the bearing housing 2 by a fastening mechanism 3. A compressor housing 6 is connected to the right side of the bearing housing 2 by a fastening bolt 5. The bearing housing 2, the turbine housing 4, and the compressor housing 6 are integrated.

A protrusion 2a is provided on an outer circumferential surface of the bearing housing 2 in the vicinity of the turbine housing 4. The protrusion 2a protrudes in a radial direction of the bearing housing 2. A protrusion 4a is provided on an outer circumferential surface of the turbine housing 4 in the vicinity of the bearing housing 2. The protrusion 4a protrudes in a radial direction of the turbine housing 4. The protrusion 2a of the bearing housing 2 and the protrusion 4a of the turbine housing 4 are fastened to each other by a band by the fastening mechanism 3. The fastening mechanism 3 includes, for example, a G coupling which clamps the protrusions 2a and 4a.

A bearing hole 2b is formed in the bearing housing 2. The bearing hole 2b penetrates through the bearing housing 2 in the left-right direction of the turbocharger C. The shaft 8 is pivotally supported in a freely rotatable manner by a bearing member 7 provided in the bearing hole 2b. At a left end of the shaft 8, a turbine impeller 9 is attached. The turbine impeller 9 is accommodated in the turbine housing 4 in a freely rotatable manner. Furthermore, a compressor impeller 10 is provided at a right end of the shaft 8. The compressor impeller 10 is accommodated in the compressor housing 6 in a freely rotatable manner.

An intake port 11 is formed in the compressor housing 6. The intake port 11 opens to the right side of the turbocharger C. The intake port 11 is connected to an air cleaner (not illustrated). In a state where the bearing housing 2 and the compressor housing 6 are connected by the fastening bolt 5, opposing surfaces of the bearing housing 2 and the compressor housing 6 form a diffuser flow passage 12. The diffuser flow passage 12 pressurizes the air. The diffuser flow passage 12 is annularly formed outward from an inner side in the radial direction of the shaft 8. The diffuser flow passage 12 communicates with the intake port 11 via the compressor impeller 10 on the aforementioned inner side in the radial direction.

Furthermore, the compressor housing 6 includes a compressor scroll flow passage 13. The compressor scroll flow passage 13 is annular. The compressor scroll flow passage 13 is positioned on an outer side in the radial direction of the shaft 8 with respect to the diffuser flow passage 12. The compressor scroll flow passage 13 communicates with an intake port of an engine (not illustrated) and the diffuser flow passage 12. When the compressor impeller 10 rotates, therefore, the air is sucked into the compressor housing 6 from the intake port 11. The sucked air is pressurized and accelerated by the action of the centrifugal force in the process of flowing through blades of the compressor impeller 10. The pressurized and accelerated air is further pressurized in the diffuser flow passage 12 and the compressor scroll flow passage 13 and then guided to the intake port of the engine.

A discharge port 14 is formed in the turbine housing 4. The discharge port 14 opens to the left side of the turbocharger C. The discharge port 14 is connected to an exhaust gas purification device (not illustrated). The turbine housing 4 includes a flow passage 15 and a turbine scroll flow passage 16. The turbine scroll flow passage 16 is annular. The turbine scroll flow passage 16 is positioned on an outer side in the radial direction of the turbine impeller 9 with respect to the flow passage 15. The turbine scroll flow passage 16 communicates with a gas inlet port (not illustrated). Exhaust gas discharged from an exhaust manifold of the engine (not illustrated) is guided to the gas inlet port. Therefore, the exhaust gas guided from the gas inlet port to the turbine scroll flow passage 16 is guided to the discharge port 14 via the flow passage 15 and the turbine impeller 9. The exhaust gas rotates the turbine impeller 9 in the process of flowing therethrough.

The turning force of the turbine impeller 9 is then transmitted to the compressor impeller 10 via the shaft 8. The turning force of the compressor impeller 10 allows the air to be pressurized and guided to the intake port of the engine as described above.

FIG. 2 is a view extracted from a one-dot chain line part of FIG. 1. As illustrated in FIG. 2, a bearing structure S is provided inside the bearing housing 2. In the bearing structure S, an oil passage 2c is formed in the bearing housing 2. Lubricating oil flows into the bearing hole 2b from the oil passage 2c. The lubricating oil is supplied to the bearing member 7 provided in the bearing hole 2b.

In the present embodiment, the bearing member 7, which is generally called a semi-floating bearing, is provided. The bearing member 7 has a main body portion 7a having an annular shape. The shaft 8 is inserted inside the main body portion 7a. On an inner circumferential surface of the main body portion 7a, two radial bearing surfaces 7b and 7c are formed. The radial bearing surfaces 7b and 7c are spaced apart in the direction of the rotational axis of the shaft 8 (hereinafter simply referred to as “axial direction”).

An oil hole 7d is formed in the main body portion 7a. The oil hole 7d penetrates through the main body portion 7a from the inner circumferential surface thereof to the outer circumferential surface thereof. A part of the lubricating oil supplied to the bearing hole 2b passes through the oil hole 7d and flows into the inner circumferential surface side of the main body portion 7a. The lubricating oil flowed into the inner circumferential surface side of the main body portion 7a is supplied to a clearance between the shaft 8 and each of the radial bearing surfaces 7b and 7c. The shaft 8 is pivotally supported by the oil film pressure of the lubricating oil supplied to the clearance between the shaft 8 and each of the radial bearing surfaces 7b and 7c.

A through hole 7e is further provided in the main body portion 7a. The through hole 7e extends from the inner circumferential surface to the outer circumferential surface. A pin hole 2d is formed in the bearing housing 2. The pin hole 2d faces the through hole 7e. The pin hole 2d penetrates a wall portion forming the bearing hole 2b. A positioning pin 20 is press-fitted into the pin hole 2d from the lower side in FIG. 2. A tip of the positioning pin 20 is inserted into the through hole 7e of the bearing member 7. The positioning pin 20 regulates rotation and movement in the axial direction of the bearing member 7.

Furthermore, the shaft 8 is provided with an oil thrower member 21 (large diameter portion) on the right side (compressor impeller 10 side) in FIG. 2 with respect to the main body portion 7a. The oil thrower member 21 is annular. The oil thrower member 21 scatters, radially outward, the lubricating oil flowing toward the compressor impeller 10 along the shaft 8 in the axial direction. In this manner, the oil thrower member 21 suppresses leakage of lubricating oil to the compressor impeller 10 side.

The main body portion 7a is formed with bearing surfaces 7f and 7g at both ends in the axial direction thereof. The bearing surface 7f is formed at the end of the main body portion 7a on the turbine impeller 9 side. The bearing surface 7g is formed at the end of the main body portion 7a on the compressor impeller 10 side. The oil thrower member 21 faces the bearing surface 7g of the main body portion 7a in the axial direction. A thrust load acts leftward in the drawing on the bearing surface 7g from the oil thrower member 21.

The shaft 8 is further provided with a collar portion 8a (large diameter portion) on the turbine impeller 9 side with respect to the main body portion 7a. The collar portion 8a faces the bearing surface 7f of the main body portion 7a in the axial direction. A thrust load acts rightward in the drawing on the bearing surface 7f from the collar portion 8a.

In this manner, the main body portion 7a is sandwiched by the oil thrower member 21 and the collar portion 8a in the axial direction while restricted from movement in the axial direction by the positioning pin 20. The lubricating oil having lubricated the radial bearing surface 7c is introduced into a clearance between the main body portion 7a and the oil thrower member 21. The lubricating oil having lubricated the radial bearing surface 7b is also introduced into a clearance between the main body portion 7a and the collar portion 8a. As a result, when the shaft 8 moves in the axial direction, the oil thrower member 21 or the collar portion 8a is supported by the oil film pressure between the oil thrower member 21 or the collar portion 8a and the main body portion 7a.

Furthermore, damper portions 7h and 7i are formed on both end sides of the outer circumferential surface of the main body portion 7a in the axial direction. The damper portions 7h and 7i suppress vibration of the shaft 8 by the oil film pressure of the lubricating oil supplied to the clearance between the inner circumferential surface of the bearing hole 2b and the main body portion 7a.

In the bearing housing 2, scattering spaces 22 and 23 are formed above the bearing hole 2b. The scattering space 22 communicates with the opening of the bearing hole 2b on the turbine impeller 9 side. The scattering space 23 also communicates with the opening of the bearing hole 2b on the compressor impeller 10 side. The scattering spaces 22 and 23 extend in the circumferential direction on an outer side in the radial direction with respect to the bearing hole 2b. The scattering spaces 22 and 23 also communicate with an oil discharge space 24. The oil discharge space 24 is formed below the bearing hole 2b. Furthermore, communicating openings 25 and 26 are formed between the bearing hole 2b and the oil discharge space 24. The communicating opening 25 communicates the bearing hole 2b and the oil discharge space 24 on the turbine impeller 9 side. The communicating opening 26 communicates the bearing hole 2b and the oil discharge space 24 on the compressor impeller 10 side.

The bearing member 7 is longer in the axial direction than the bearing hole 2b. The bearing surfaces 7f and 7g formed at both ends of the main body portion 7a each protrude from the bearing hole 2b in the axial direction. Therefore, the lubricating oil after having lubricated the radial bearing surface 7b and the bearing surface 7f scatters radially outward from the bearing surface 7f. Also, the lubricating oil supplied to the damper portion 7h scatters from the opening of the bearing hole 2b on the turbine impeller 9 side. Most of the scattered lubricating oil is discharged to the oil discharge space 24 via the scattering space 22 and the communicating opening 25 also with the help of the action of the centrifugal force accompanying the rotation of the collar portion 8a.

Similarly, the lubricating oil after having lubricated the radial bearing surface 7c and the bearing surface 7g scatters radially outward from the bearing surface 7g. Furthermore, the lubricating oil supplied to the damper portion 7i scatters from the bearing hole 2b toward the compressor impeller 10. Most of the scattered lubricating oil is discharged to the oil discharge space 24 via the scattering space 23 and the communicating opening 26 also with the help of the action of the centrifugal force accompanying the rotation of the oil thrower member 21.

Here, the shaft 8 (including the turbine impeller 9 and the compressor impeller 10) described above is designed according to specifications of the turbocharger C. Therefore, the shape or dimensions of the shaft 8 differ for each specification. Furthermore, for example, if the capacity of the turbocharger C is changed, a thrust load performance required for the bearing member 7 also changes. Therefore, for each specification of the turbocharger C, the shape of the thrust bearing surface, mainly an area serving as a thrust bearing also differs. In this manner, not only the shaft 8 but also the bearing member 7 having different areas for the bearing surfaces 7f and 7g are designed and manufactured for each specification of the turbocharger C. Therefore, a large number of parts are manufactured and stored. In the present embodiment, the shaft 8 is structured as follows in order to share parts among different specifications.

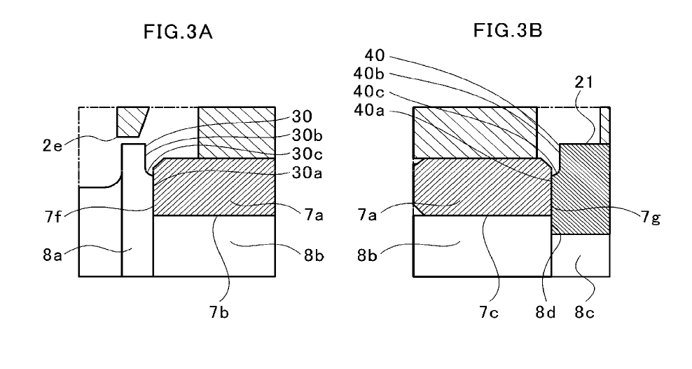

FIG. 3A is a view illustrating a broken line part on the left side in FIG. 2. FIG. 3B is a view illustrating a broken line part on the right side in FIG. 2. As illustrated in FIGS. 3A and 3B, a bearing surface 7f is formed on and end surface of the main body portion 7a of the bearing member 7 on the turbine impeller 9 side. In addition, a bearing surface 7g is formed on an end surface of the main body portion 7a on the compressor impeller 10 side. Both of the end surfaces of the bearing member 7 are chamfered. Therefore, strictly speaking, outer diameters of the bearing surfaces 7f and 7g are smaller than the outer diameter of the main body portion 7a.

As illustrated in FIG. 3A, the collar portion 8a of the shaft 8 has a larger diameter than that of a small diameter portion 8b of the shaft 8. In other words, the collar portion 8a protrudes radially from the small diameter portion 8b outward from the main body portion 7a. Here, the small diameter portion 8b includes a portion of the shaft 8 facing the radial bearing surface 7b. The small diameter portion 8b is inserted through the main body portion 7a. The outer diameter of the collar portion 8a is larger than the outer diameters of the bearing surface 7f and the main body portion 7a. The collar portion 8a is positioned closer to the turbine impeller 9 than the main body portion 7a is. A bearing opposing surface 30 faces toward the main body portion 7a side (bearing surface 7f side). That is, the end surface of the main body portion 7a faces the bearing opposing surface 30.

The bearing opposing surface 30 includes a received surface 30a, a separation surface 30b (separation portion), and a step portion 30c (separation portion, step). The received surface 30a is positioned inward from the separation surface 30b in the radial direction of the shaft 8. The received surface 30a communicates with the small diameter portion 8b. More specifically, the received surface 30a rises substantially vertically in the radial direction from the small diameter portion 8b. In other words, the received surface 30a extends in the radial direction from the small diameter portion 8b. Meanwhile, the separation surface 30b is positioned radially outward from the received surface 30a. The separation surface 30b is spaced apart from the bearing surface 7f more than the received surface 30a is. The separation surface 30b is positioned on the opposite side to the bearing surface 7f (left side in FIG. 3A, the side spaced apart from the bearing surface 7f) with respect to the received surface 30a. More specifically, the step portion 30c is provided between the received surface 30a and the separation surface 30b. The separation surface 30b communicates with the outer peripheral edge of the received surface 30a via the step portion 30c. That is, in the collar portion 8a, the received surface 30a facing the bearing surface 7f in the direction of the rotational axis and the separation portion (separation surface 30b and step portion 30c) are formed. The separation portion (separation surface 30b and step portion 30c) extends from the outer periphery of the received surface 30a. The separation portion (separation surface 30b and step portion 30c) is spaced apart from the bearing surface 7f more than the received surface 30a is.

The outer diameter of the step portion 30c gradually increases from the received surface 30a side toward the separation surface 30b. That is, the outer diameter of the step portion 30c gradually increases as axially away from the bearing surface 7f. As a result of this, a step is formed between the received surface 30a and the separation surface 30b. The separation surface 30b is positioned on a radially outer side than the received surface 30a and is spaced apart from the bearing surface 7f more than the received surface 30a is. Note that the separation surface 30b extends along the radial direction of the shaft 8 similarly to the received surface 30a. That is, the step portion 30c connects the outer periphery of the received surface 30a and the inner periphery of the separation surface 30b having different diameters.

Moreover, the outer diameter of the received surface 30a is smaller than the outer diameter of the bearing surface 7f. In other words, the received surface 30a has a dimension that is accommodated within the range of the bearing surface 7f. As a result, an area of the bearing surface 7f that functions as a thrust bearing surface is given as a portion facing the received surface 30a. Here, the area that functions as the thrust bearing surface is an area that receives the thrust load acting on the bearing member 7 from the collar portion 8a. A part of the bearing surface 7f in the vicinity of the outer peripheral edge (a part positioned radially outward from the received surface 30a and facing the separation surface 30b) does not function as the thrust bearing surface.

This means that the area functioning as the thrust bearing surface (that is, the withstanding thrust load performance required of the bearing member 7) is managed by the collar portion 8a of the shaft 8 and not by the bearing surface 7f of the bearing member 7. As described above, the shaft 8, the turbine impeller 9, and the compressor impeller 10 are designed in accordance with specifications of the turbocharger C. At this time, an area that functions as the thrust bearing surface is determined from a required withstanding thrust load performance. Then, the received surface 30a is formed so as to secure the determined area. In this manner, it is possible to manage the area that functions as a thrust bearing surface from the shaft 8 side which is designed differently depending on specifications. Therefore, there is no need to modify the bearing surface 7f for each turbocharger C having different specifications.

Furthermore, here, the bearing member 7 is structured as a so-called thrust integral type which is subjected to the thrust load in addition to the radial load. The collar portion 8a of the shaft 8 includes the separation surface 30b extending on an outer side in the radial direction with respect to the bearing surface 7f and the main body portion 7a. Meanwhile, the bearing housing 2 includes a protruding wall portion 2e. The protruding wall portion 2e faces the outer circumferential surface of the separation surface 30b with a slight clearance therebetween. At this time, the separation surface 30b is positioned closer to the bearing member 7 (the main body portion 7a side and the bearing surface 7f side) than the protruding wall portion 2e is. More specifically, a part of the outer circumferential surface of the collar portion 8a on the turbine impeller 9 side faces the protruding wall portion 2e in the radial direction. A part of the outer circumferential surface of the collar portion 8a on the side of the separation surface 30b is positioned closer to the bearing member 7 (the main body portion 7a side and the bearing surface 7f side) than the protruding wall portion 2e is. Therefore, a passage communicating with the scattering space 22 is positioned radially outward from the separation surface 30b. In other words, the position of the outer diameter of the separation surface 30b in the axial direction overlaps with the opening of the scattering space 22. By setting a distance in the axial direction between the received surface 30a and the separation surface 30b (that is, the amount of step difference) so as to achieve such a relationship, it is possible to improve the oil sealing performance. That is, according to the turbocharger C of the present embodiment, the oil sealing performance is secured by including the separation surface 30b.

Furthermore as illustrated in FIG. 3B, the oil thrower member 21 provided to the shaft 8 has a larger diameter than that of the small diameter portion 8b. The small diameter portion 8b includes a portion of the shaft 8 facing the radial bearing surface 7c. Specifically, the shaft 8 has a tip portion 8c on the compressor impeller 10 side with respect to the small diameter portion 8b. The tip portion 8c has a smaller diameter than that of the small diameter portion 8b. A step surface 8d is formed between the small diameter portion 8b and the tip portion 8c. The step surface 8d extends in the radial direction.

The tip portion 8c is inserted through the oil thrower member 21 until the oil thrower member 21 comes into contact with the step surface 8d. Next, the compressor impeller 10 is inserted. Then, while the oil thrower member 21 is clamped between the step surface 8d and the compressor impeller 10, a tip of the tip portion 8c is bolted. In this manner, the oil thrower member 21 and the compressor impeller 10 are attached to the shaft 8. At this time, a slight clearance is kept between the main body portion 7a (bearing surface 7g) of the bearing member 7 and the oil thrower member 21.

More specifically, the outer diameter of the oil thrower member 21 is larger than those of the bearing surface 7g and the main body portion 7a. The oil thrower member 21 is positioned closer to the compressor impeller 10 than the main body portion 7a is. A bearing opposing surface 40 faces toward the main body portion 7a side (bearing surface 7g side). That is, the end surface of the main body portion 7a faces the bearing opposing surface 40.

The bearing opposing surface 40 includes a received surface 40a and a separation surface 40b (separation portion). The received surface 40a is positioned inward from the separation surface 40b in the radial direction of the shaft 8. More specifically, the received surface 40a faces the step surface 8d and the bearing surface 7g. Furthermore, the received surface 40a rises substantially vertically in the radial direction from the shaft 8. In other words, the received surface 40a extends in the radial direction from the shaft 8. Meanwhile, the separation surface 40b is positioned radially outward from the received surface 40a. The separation surface 40b is spaced apart from the bearing surface 7g more than the received surface 40a is. The separation surface 40b is positioned on the opposite side to the bearing surface 7g (right side in FIG. 3B, the side spaced apart from the bearing surface 7g) with respect to the received surface 40a. More specifically, a step portion 40c (separation portion, step) is provided between the received surface 40a and the separation surface 40b. The separation surface 40b communicates with the outer peripheral edge of the received surface 40a via the step portion 40c.

The outer diameter of the step portion 40c gradually increases from the received surface 40a side toward the separation surface 40b. That is, the outer diameter of the step portion 40c gradually increases as the step portion 40c extends from the bearing surface 7g in the axial direction. A step is formed between the received surface 40a and the separation surface 40b. The separation surface 40b is positioned on a radially outer side than the received surface 40a and is spaced apart from the bearing surface 7g more than the received surface 40a is. Note that the separation surface 40b extends along the radial direction of the shaft 8 similarly to the received surface 40a. That is, the step portion 40c connects the outer periphery of the received surface 40a and the inner periphery of the separation surface 40b having different diameters.

Moreover, the outer diameter of the received surface 40a is smaller than the outer diameter of the bearing surface 7g. In other words, the received surface 40a has a dimension that is accommodated within the range of the bearing surface 7g. As a result, an area of the bearing surface 7g that functions as a thrust bearing surface is given as a portion facing the received surface 40a. Here, the area that functions as the thrust bearing surface is an area that receives the thrust load acting on the bearing member 7 from the oil thrower member 21. A part of the bearing surface 7g in the vicinity of the outer peripheral edge (a part positioned radially outward from the received surface 40a and facing the separation surface 40b) does not function as the thrust bearing surface.

This means that the area functioning as the thrust bearing surface (that is, the withstanding thrust load performance required for the bearing member 7) is managed by the oil thrower member 21 and not by the bearing surface 7g of the bearing member V. If the diameter of the shaft 8 is modified in accordance with the specifications of the turbocharger C, a hole diameter of the oil thrower member 21 through which the tip portion 8c is inserted also has to be modified. Therefore, similarly to the collar portion 8a, when the area functioning as the thrust bearing surface is managed by the oil thrower member 21 whose design differs according to a specification thereof, there is no need to modify the bearing surface 7g for each turbocharger C having different specifications.

Moreover, the bearing opposing surface 40 of the oil thrower member 21 extends on an outer side in the radial direction with respect to the bearing surface 7g and the main body portion 7a. A passage communicating with the scattering space 23 is positioned radially outward from the separation surface 40b. In other words, the position of the outer diameter of the separation surface 40b in the axial direction overlaps with the opening of the scattering space 23. By setting a distance in the axial direction between the received surface 40a and the separation surface 40b (that is, the amount of step difference) so as to achieve such a relationship, it is possible to secure the oil sealing performance also on the compressor impeller 10 side.

As described above, in the collar portion 8a and the oil thrower member 21 provided to the shaft 8, the radial lengths of the received surfaces 30a and 40a (in other words, the radial lengths of the separation surfaces 30b and 40b) are controlled. In this manner, the area that functions as the thrust bearing surface is managed. This eliminates the need to modify the bearing surfaces 7f and 7g for each turbocharger C having different specifications. Therefore, the bearing member 7 can be shared by turbochargers C having different specifications.

Furthermore, the outer diameters of the collar portion 8a and the oil thrower member 21 are increased by the separation surfaces 30b and 40b provided radially outward from the received surfaces 30a and 40a, respectively. The collar portion 8a and the oil thrower member 21 have a function of preventing oil leakage to the turbine impeller 9 side or the compressor impeller 10 side in addition to the function of applying the thrust load to the bearing member 7. If the diameters increase with the separation surfaces 30b and 40b provided, the centrifugal force increases accordingly. As a result, the force for scattering lubricating oil in the radial direction increases, thereby improving the oil sealing performance.

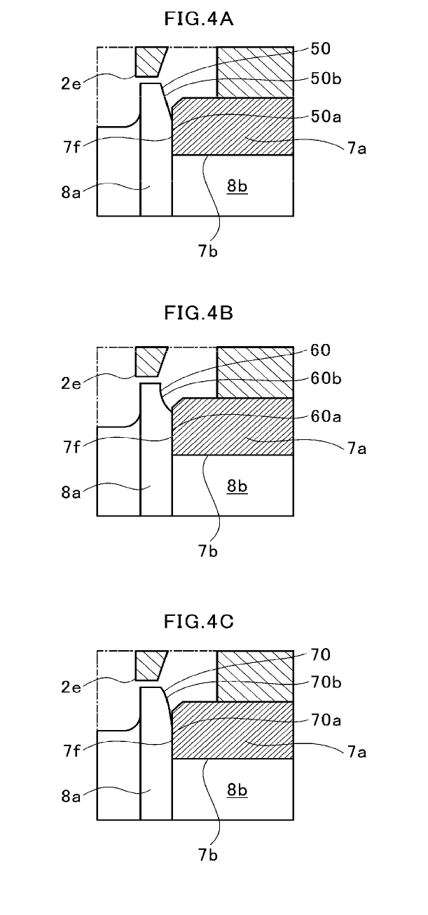

FIG. 4A is a view for explaining a first modification. FIG. 4B is a view for explaining a second modification. FIG. 4C is a view for explaining a third modification. In FIGS. 4A, 4B, and 4C, parts corresponding to FIG. 3A are illustrated. Note that, in the first to third modifications described below, a bearing opposing surface 30 of a shaft 8 is different from that of the embodiment described above. The other configurations are the same as those of the embodiment described above. Therefore, in the following description, only parts different from the above embodiment will be described in order to avoid redundant description. In the first modification illustrated in FIG. 4A, a collar portion 8a is positioned closer to a turbine impeller 9 than a main body portion 7a is. A bearing opposing surface 50 faces toward the main body portion 7a side (bearing surface 7f side). That is, an end surface of the main body portion 7a faces the bearing opposing surface 50.

The bearing opposing surface 50 includes a received surface 50a and a separation surface 50b (separation portion). The received surface 50a is positioned inward from the separation surface 50b in the radial direction of the shaft 8. The received surface 50a communicates with a small diameter portion 8b. The separation surface 50b is positioned radially outward from the received surface 50a. The separation surface 50b is spaced apart from the bearing surface 7f more than the received surface 50a is. More specifically, a radially inner side of the separation surface 50b communicates with the received surface 50a. The separation surface 50b has a tapered shape in which the diameter gradually increases as the separation surface 50b extends from the bearing surface 7f in the axial direction. Also in the first modification, the outer diameter of the received surface 50a is smaller than the outer diameter of the main body portion 7a. In addition, the outer diameter of the separation surface 50b is larger than the outer diameters of the bearing surface 7f and the main body portion 7a.

Moreover, in the second modification illustrated in FIG. 4B, a collar portion 8a is positioned closer to a turbine impeller 9 than a main body portion 7a is. A bearing opposing surface 60 faces toward the main body portion 7a side (bearing surface 7f side). That is, an end surface of the main body portion 7a faces the bearing opposing surface 60. The bearing opposing surface 60 includes a received surface 60a and a separation surface 60b. The received surface 60a is positioned inward from the separation surface 60b in the radial direction of a shaft 8. The received surface 60a communicates with a small diameter portion 8b. The separation surface 60b is positioned radially outward from the received surface 60a. The separation surface 60b is spaced apart from the bearing surface 7f more than the received surface 60a is. More specifically, a radially inner side of the separation surface 60b communicates with the received surface 60a. The separation surface 60b is a curved surface having a curvature center on the main body portion 7a side with respect to the separation surface 60b. Also in the second modification, the outer diameter of the received surface 60a is smaller than the outer diameter of the main body portion 7a. The outer diameter of the separation surface 60b is larger than the outer diameters of the bearing surface 7f and the main body portion 7a.

Moreover, in the third modification illustrated in FIG. 4C, a collar portion 8a is positioned closer to a turbine impeller 9 than a main body portion 7a is. A bearing opposing surface 70 faces toward the main body portion 7a side (bearing surface 7f side). That is, an end surface of the main body portion 7a faces the bearing opposing surface 70. The bearing opposing surface 70 includes a received surface 70a and a separation surface 70b (separation portion). The received surface 70a is positioned inward from the separation surface 70b in the radial direction of the shaft 8. The received surface 70a communicates with a small diameter portion 8b. The separation surface 70b is positioned radially outward from the received surface 70a. The separation surface 70b is spaced apart from the bearing surface 7f more than the received surface 70a is. More specifically, a radially inner side of the separation surface 70b communicates with the received surface 70a. The separation surface 70b is a curved surface having the curvature center on the turbine impeller 9 (the side opposite to the main body portion 7a) side with respect to the separation surface 70b. Also in the third modification, the outer diameter of the received surface 70a is smaller than the outer diameter of the main body portion 7a. The outer diameter of the separation surface 70b is larger than the outer diameters of the bearing surface 7f and the main body portion 7a.

As described above, similar operational effects to those of the embodiment described above can be implemented also by the first to third modifications. Note that here the case where the bearing opposing surfaces 50, 60, and 70 are provided in the collar portion 8a has been described. However, the bearing opposing surface 40 of the oil thrower member 21 in the above embodiment may have a similar structure to the first to third modifications. In this case, a bearing opposing surface 50, 60, or 70 is provided in the oil thrower member 21.

Note that in the above embodiment and modifications, the cases where the radial bearing surfaces 7b and 7c that receive the radial load and the bearing surfaces 7f and 7g that receive the thrust load are provided in one bearing member 7 have been described. However, a bearing surface that receives the radial load and a bearing surface that receives the thrust load may be provided in separate bearing members.

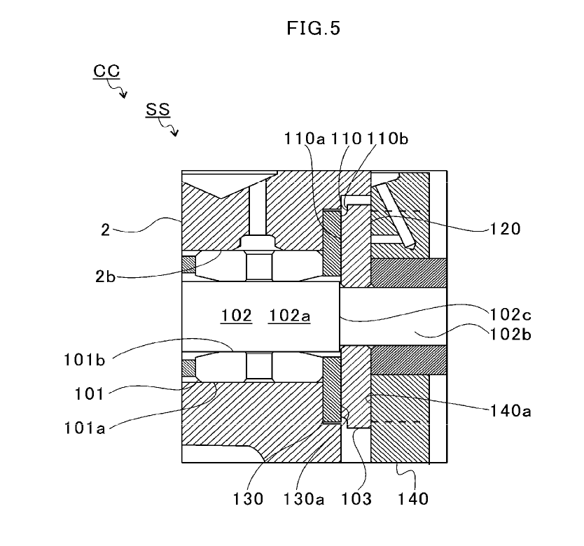

FIG. 5 is a view for explaining a bearing structure SS of a second embodiment. Note that, in the second embodiment, only the bearing structure SS is different from the above embodiment. Other structures are the same as those of the above embodiment. Therefore, in the following a structure same as that of the above embodiment is denoted by the same symbol, and descriptions thereof are omitted in order to avoid redundant description.

In the turbocharger CC of the second embodiment, a bearing member 101 is provided in a bearing hole 2b of a bearing housing 2. In FIG. 5, only one bearing member 101 is illustrated. Actually, two bearing members 101 are provided while spaced apart in the axial direction of a shaft 102. A bearing member 101 includes a main body portion 101a. The main body portion 101a is annular. The shaft 8 is inserted through the main body portion 101a. On an inner circumferential surface of the main body portion 101a, a bearing surface 101b is formed. The shaft 102 includes a pivotally-supported portion 102a. The pivotally-supported portion 102a includes a portion facing the main body portion 101a in the radial direction. The pivotally-supported portion 102a is pivotally supported in a freely rotatable manner by the bearing member 101. The shaft 102 further includes a tip portion 102b. The tip portion 102b is positioned closer to the compressor impeller 10 (the right side in FIG. 5, collar 103 side) than the pivotally-supported portion 102a is. The tip portion 102b has a smaller diameter than the pivotally-supported portion 102a. A step portion 102c (step) is formed between the pivotally-supported portion 102a and the tip portion 102b. The step portion 102c extends in the radial direction.

The tip portion 102b is attached with the collar 103 (large diameter portion). The collar 103 has a bearing opposing surface 110 and a bearing opposing surface 120. The bearing opposing surface 110 faces the turbine impeller 9 side. The bearing opposing surface 120 faces the compressor impeller 10 side. The inner diameter side of the bearing opposing surface 110 of the collar 103 is in contact with the step portion 102c. The collar 103 is provided at the tip portion 102b. The bearing housing 2 is provided with a turbine-side bearing member 130 (bearing member). The turbine-side bearing member 130 faces the bearing opposing surface 110. The bearing housing 2 is further provided with a compressor-side bearing member 140. The compressor-side bearing member 140 faces the bearing opposing surface 120. That is, the collar 103 is positioned between the turbine-side bearing member 130 and the compressor-side bearing member 140.

The turbine-side bearing member 130 includes a bearing surface 130a. The bearing surface 130a faces the bearing opposing surface 110 of the collar 103. The compressor-side bearing member 140 includes a bearing surface 140a. The bearing surface 140a faces the bearing opposing surface 120 of the collar 103. Moreover, lubricating oil is supplied between the bearing surface 130a and the bearing opposing surface 110 and clearance between the bearing surface 140a and the bearing opposing surface 120. The shaft 102 is supported by the oil film pressure of the lubricating oil.

Here, the bearing opposing surface 110 has a received surface 110a and a separation surface 110b (separation portion). The received surface 110a is positioned inward from the separation surface 110b in the radial direction of the shaft 102. More specifically, the received surface 110a faces the step portion 102c and the bearing surface 130a. The received surface 110a rises substantially vertically in the radial direction from the shaft 8. In other words, the received surface 110a extends in the radial direction from the shaft 8. Meanwhile, the separation surface 110b is positioned radially outward from the received surface 110a. The separation surface 110b is spaced apart from the bearing surface 130a more than the received surface 110a is. More specifically, a radially inner side of the separation surface 110b communicates with the received surface 110a. The separation surface 110b has a diameter that gradually increases as the separation surface 110b extends from the bearing surface 130a in the axial direction. A radially outer side of the separation surface 110b extends substantially in the radial direction of the shaft 102. The outer diameter of the separation surface 110b is larger than the outer diameters of the turbine-side bearing member 130 and the bearing surface 130a.

In this manner, the separation surface 110b is positioned radially outward from the received surface 110a. The separation surface 110b is spaced apart from the bearing surface 130a more than the received surface 110a is. Moreover, the outer diameter of the received surface 110a is smaller than the outer diameter of the bearing surface 130a. In other words, the received surface 110a has a dimension that is accommodated within the range of the bearing surface 130a. As a result, an area of the bearing surface 130a that functions as a thrust bearing surface is given as a portion facing the received surface 110a. Here, the area that functions as the thrust bearing surface is an area that receives the thrust load acting on the turbine-side bearing member 130 from the collar 103. In other words, a part of the bearing surface 130a in the vicinity of the outer peripheral edge (that is, a part positioned radially outward from the received surface 110a and facing the separation surface 110h) does not function as the thrust bearing surface.

This means that the area functioning as the thrust bearing surface (that is, the withstanding thrust load performance required for the turbine-side bearing member 130) is managed by the collar 103 and not by the bearing surface 130a of the turbine-side bearing member 130. If the diameter of the shaft 102 is modified in accordance with specifications of the turbocharger CC, the hole diameter of the collar 103 through which the tip portion 102b is inserted also has to be modified. Therefore, when the area functioning as the thrust bearing surface is managed by the collar 103 whose design differs according to a specification thereof, there is no need to modify the bearing surface 130a for each turbocharger CC having different specifications. That is, also in this second embodiment, it is enabled to share parts in a similar manner as described above.

Note that in the second embodiment as well, the bearing opposing surface 110 may have a similar shape to that of the bearing opposing surface 30, 50, 60, or 70. Here, the separation surface 110b is provided only on the bearing opposing surface 110 of the collar 103. However, the bearing opposing surface 120 may have a similar shape to that of the bearing opposing surface 110. In the turbocharger CC, however, the thrust load acting on the compressor impeller 10 side from the turbine impeller 9 side is larger than the thrust load acting on the turbine impeller 9 side from the compressor impeller 10 side. That is, the bearing opposing surface 110 requires a lower withstanding thrust load performance than that required by the bearing opposing surface 120. Therefore, as described above, by including the received surface 110a and the separation surface 110b only on the bearing opposing surface 110, it is possible to effectively reduce the mechanical loss.

Although the embodiment of the present disclosure has been described with reference to the accompanying drawings, it is naturally understood that the present disclosure is not limited to the above embodiment. It is clear that those skilled in the art can conceive various modifications or variations within the scope described in the claims, and it is understood that they are naturally also within the technical scope of the present disclosure.

For example, in the embodiments and modifications described above, the cases where the outer diameter of the received surfaces 30a, 40a, 50a, 60a, 70a, and 110a are smaller than the outer diameters of the bearing surfaces 7f, 7g, 7f, 7f, 7f, and 130a, respectively, have been described. However, a dimensional relationship between a received surface and a bearing surface is not limited to the above. Therefore, for example, in the above embodiment, the outer diameter of the received surface 30a may be larger than the outer diameter of the bearing surface 7f.

In the embodiments and modifications described above, the cases where the outer diameters of the collar portion 8a and the oil thrower member 21 are greater than the outer diameter of the main body portion 7a and the outer diameter of the collar 103 is greater than the outer diameter of the turbine-side bearing member 130 have been described. However, these dimensional relationships are also not limited to the above embodiment nor the modifications.

### INDUSTRIAL APPLICABILITY

The present disclosure can be applied to a turbocharger including a shaft and a bearing surface.

What is claimed is:

1. A turbocharger comprising:
a housing;
a bearing member provided in the housing and having a bearing surface; and
a shaft having a received surface facing the bearing surface in a direction of a rotational axis and a large diameter portion extending from an outer periphery of the received surface and formed with a separation portion spaced apart from the bearing surface more than the received surface is.

2. The turbocharger according to claim 1, wherein the separation portion has a tapered shape.

3. The turbocharger according to claim 1, wherein the separation portion comprises a separation surface positioned radially outward from the received surface and a step positioned between the separation surface and the received surface.

4. The turbocharger according to claim 1, wherein an outer diameter of the received surface is smaller than an outer diameter of the bearing surface.

5. The turbocharger according to claim 2, wherein an outer diameter of the received surface is smaller than an outer diameter of the bearing surface.

6. The turbocharger according to claim 3, wherein an outer diameter of the received surface is smaller than an outer diameter of the bearing surface.

7. The turbocharger according to claim 1, wherein the bearing member has the bearing surface at an end of an annular main body portion through which the shaft is inserted.

8. The turbocharger according to claim 2, wherein the bearing member has the bearing surface at an end of an annular main body portion through which the shaft is inserted.

9. The turbocharger according to claim 3, wherein the bearing member has the bearing surface at an end of an annular main body portion through which the shaft is inserted.

10. The turbocharger according to claim 4, wherein the bearing member has the bearing surface at an end of an annular main body portion through which the shaft is inserted.

11. The turbocharger according to claim 5, wherein the bearing member has the bearing surface at an end of an annular main body portion through which the shaft is inserted.

12. The turbocharger according to claim 6, wherein the bearing member has the bearing surface at an end of an annular main body portion through which the shaft is inserted.
